(19) United States
(12) Patent Application Publication
(10) Pub. No.: US 2007/0198757 A1
(43) Pub. Date: Aug. 23, 2007

(54) Data processing system with hardware polling processor

(75) Inventor: Ki-Hong Kim, Suwon-si (KR)

Correspondence Address: F. Chau & Associates, LLC, 130 Woodbury Road, Woodbury, NY, 11797, US

(73) Assignee: Samsung Electronics Co., Ltd., Suwon-si (KR)

(21) Appl. No.: 11/654,171

(22) Filed: Jan. 17, 2007

(30) Foreign Application Priority Data
Feb. 7, 2006 (KR) 2006-11853

(51) Int. Cl. G06F 3/00

(52) U.S. Cl. 710/46

(57) ABSTRACT

A data processing system includes a processor, a peripheral device conducting an operation requested by the processor, a clock/power control unit supplying a clock signal to the processor, and a hardware polling processor detecting current state data output from the peripheral device and regulating the clock/power control unit to interrupt the clock signal to the processor in accordance with a result of the detection, during a state read operation for detecting current state data of the peripheral device.

### CROSS-REFERENCE TO RELATED APPLICATIONS

This U.S. non-provisional patent application claims priority under 35 U.S.C. §119 of Korean Patent Application No. 2006-11853 filed on Feb. 7, 2006, the entire contents of which are hereby incorporated by reference.

### BACKGROUND

1. Technical Field

The present invention disclosed herein relates to data processing systems and more particularly, to a system and method for reducing power consumption in data processing systems.

2. Discussion of Related Art

In data processing systems, a central processing unit (CPU) typically requests a specific operation from a peripheral device and thereafter periodically checks whether the requested operation has been completed. The periodic check is referred to as a ‘polling’ operation. According to such a polling operation, the CPU periodically reads values stored in a state register of the peripheral device. In this case, the CPU periodically monitors a state (e.g., a standby or busy state) of the peripheral device by means of a program stored in a program memory. The CPU and the program memory continue to consume power while a state of the peripheral device is being periodically monitored through the polling operation. The rate of current or power consumption by the CPU and the program memory during polling is similar to that when performing other operations.

Therefore, a need exists for reducing power consumed by the CPU and/or the program memory when the peripheral device is being monitored through the polling operation.

### SUMMARY OF THE INVENTION

According to an embodiment of the present invention a data processing system comprises a processor, a peripheral device conducting an operation requested by the processor, a clock/power control unit supplying a clock signal to the processor, and a hardware polling processor detecting current state data output from the peripheral device and regulating the clock/power control unit to interrupt the clock signal to the processor in accordance with a result of the detection, during a state read operation for detecting current state data output from the peripheral device.

In an embodiment, when the clock signal is interrupted to the processor, the hardware polling processor conducts the state read operation.

In an embodiment, when the state data output from the peripheral device represent a standby state, the hardware polling processor regulates the clock/power control unit to supply the processor with the clock signal.

In an embodiment, the processor generates a hardware polling flag signal when the current state data output from the peripheral device match previous state data output from the peripheral device.

In an embodiment, the hardware polling processor stores an address, which is to be provided to the peripheral device, and the state data output from the peripheral device, in response to the hardware polling flag signal.

In an embodiment, when the processor requests the state read operation from the peripheral device after generation of the hardware polling flag signal, the hardware polling processor determines whether the current state data output from the peripheral device match with the previously stored state data.

In an embodiment, when the current state data output from the peripheral device match the previously stored state data, the hardware polling processor regulates the clock/power control unit to interrupt the clock signal toward the processor.

In an embodiment, when the current state data output from the peripheral device mismatch the previously stored state data, the hardware; polling processor regulates the clock/power control unit to supply the processor with the clock signal.

In an embodiment, when a command output from the processor is to instruct the state read operation, the hardware polling processor stores an address, which is to be provided to the peripheral device, and the current state data output from the peripheral device, in response to the hardware polling flag signal.

In an embodiment, when the current state data output from the peripheral device match with the previously stored state data, the hardware polling processor regulates the clock/power control unit to interrupt the clock signal to the processor and to lower a power source voltage less than a target level.

In an embodiment, the hardware polling processor comprises: a control logic circuit operating in response to the hardware polling flag signal; a register regulated by the control logic circuit, storing an address output to the peripheral device and the current state data output from the peripheral device when the hardware polling flag signal is generated; and a comparator regulated by the control logic circuit, comparing the current state data with the stored state data of the register.

In an embodiment, when the current state data output from the peripheral device match the previously stored state data of the register, the comparator generates a hardware polling enable signal.

In an embodiment, the clock/power control unit interrupts the clock signal to the processor in response to activation of the hardware polling enable signal.

In an embodiment, when there is an interrupt during the state read operation by the hardware polling processor, the control logic circuit regulates the comparator to deactivate the hardware polling enable signal.

In an embodiment, after activation of the hardware polling enable signal, the comparator deactivates the hardware polling enable signal when the current state data output from the peripheral device mismatch the previously stored state data of the register.

In an embodiment, the clock/power control unit supplies the clock signal to the processor in response to deactivation of the hardware polling enable signal.

According to an embodiment of the present invention, a data processing system comprises a processor, a peripheral device conducting an operation requested by the processor, a clock/power control unit supplying a clock signal to the processor, and a hardware-polling processor regulating the clock/power control unit during a state read operation for detecting current state data of the peripheral device. The processor generates a first hardware polling flag signal when the current state data of the peripheral device match previous state data. The hardware polling processor comprises a control logic circuit operating in response to the first hardware polling flag signal output from the processor, a register regulated by the control logic circuit, storing an address output to the peripheral device and the current state data of the peripheral device when the first hardware polling flag signal is generated, and a comparator regulated by the control logic circuit, comparing the current state data with stored state data of the register. The comparator generates a second hardware polling enable signal when the current state data of the peripheral device match the stored state data of the register. The clock/power control unit interrupts the clock signal to the processor in response to activation of the hardware polling enable signal.

In an embodiment, after activation of the second hardware polling enable signal, the comparator deactivates the hardware polling enable signal when the current state data output from the peripheral device mismatch with the previously stored state data of the register.

In an embodiment, wherein the clock/power control unit supplies the clock signal to the processor in response to deactivation of the hardware polling enable signal.

In an embodiment, when a command output from the processor is to instruct the state read operation, the hardware polling processor stores the address, which is to be provided to the peripheral device, and the current state data output from the peripheral device, in response to the first hardware polling flag signal.

In an embodiment, when there is an interrupt during the read state operation by the hardware polling processor, the control logic circuit regulates the comparator to deactivate the second hardware polling enable signal.

According to an embodiment of the present invention, a data processing system comprises first and second processors, a memory shared by the first and second processors, including a field for storing operation state data of the first and second processors, and first and second hardware polling processors configured to process state read operations in correspondence each with the first and second processors, wherein each of the first and second hardware polling processors is the hardware polling processor described in claim 1.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified. In the figures,

FIG. 1 is a block diagram illustrating a data processing system in accordance with an embodiment of the present invention;

FIG. 2 is a block diagram illustrating a data processing system in accordance with an embodiment of the present invention; and

FIG. 3 is a block diagram illustrating a data processing system in accordance with an embodiment of the present invention.

### DETAILED DESCRIPTION OF PREFERRED EMBODIMENTS

Preferred embodiments of the present invention will be described below in more detail with reference to the accompanying drawings, showing an exemplary polling operation mode according to an embodiment of the present invention. The present invention may, however, be embodied in different forms and should not be constructed as limited to embodiments set forth herein. Rather, embodiments are provided so that this disclosure will be thorough and complete, and will fully convey the scope of the present invention to those skilled in the art. Like reference numerals refer to like elements throughout the accompanying figures.

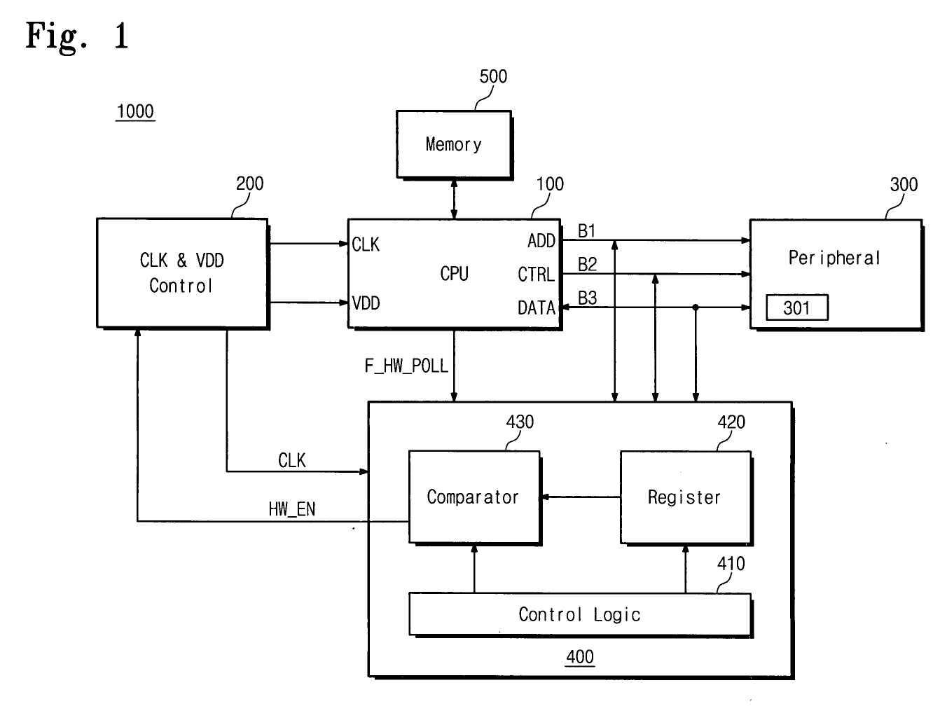

FIG. 1 is a block diagram schematically illustrating a data processing system 1000 in accordance with an embodiment of the present invention. The data processing system 1000 may be a mobile apparatus operating using power supplied from a battery (not shown). It is to be understood that the data processing system 1000 is not restrictive to the mobile apparatus. For example, the data processing system 1000 may be a memory card, etc. The data processing system 1000, as shown in FIG. 1, is comprised of a CPU 100 or processor, a clock/power control unit 200, a peripheral device 300, a hardware polling processor 400, and a program memory 500.

The CPU 100 receives a clock signal CLK and a power source voltage VDD from the clock/power control unit 200. The. CPU 100 is configured to request an operation from the peripheral device 300 and to determine whether the requested operation has been completed. Whether the requested operation has been completed is determined by checking state data stored in a state register 301 of the peripheral device 300. For example, after requesting an operation from the peripheral device 300, the CPU 100 periodically outputs state read commands and addresses to the peripheral device 300 by means of a program stored in the program memory 500. The CPU 100 checks state data provided from the peripheral device and determines whether the requested operation has been completed. The CPU 100 generates a polling flag signal F_HW_POLL when state data read from the peripheral device 300 match the previous state data.

Referring to FIG. 1, the clock/power control unit 200 is configured to generate the clock signal CLK and the power source voltage VDD, which are used in the data processing system 1000. When a hardware polling enable signal HW_EN is activated by the hardware polling processor 400, the clock/power control unit 200 operates to interrupt the clock signal CLK supplied to the CPU 100. When a hardware polling enable signal HW_EN is activated by the hardware polling processor 400, the clock/power control unit 200 may also operate to interrupt the clock signal CLK applied to the CPU 100 and the program memory 500, and to lower the power source voltage VDD supplied into the CPU 100 and the program memory 500.

The peripheral device 300 and the state register 301 that stores state data representing a condition of operation requested by the CPU 100 operate under regulation of the CPU 100. The peripheral device 300 outputs state data to the CPU 100 from the state register 301 when a command instructing a state read operation is input from the CPU 100. Here, an address is transferred to the peripheral device 300 from the CPU 100 through an address bus B1. The command for the state read operation is transferred to the peripheral device 300 from the CPU 100 through a control bus B2. The state data are transferred to the CPU 100 from the peripheral device 300 through a data bus B3.

The hardware polling processor 400 is configured to process the polling or state read operation, which is received from the CPU 100. The hardware polling processor 400 operates in response to the hardware polling flag signal F_HW_POLL provided by the CPU, and stores state data output from the peripheral device 300 when the state read operation is requested by the CPU 100. The hardware polling processor 400 detects whether current sate data are identical to the previous state data. If the current state data match the previous state data, the hardware polling processor 400 generates the hardware polling enable signal HW_EN. This enables the clock/power control unit 200 to interrupt the clock signal CLK, or clock signal CLK and target level of power source voltage VDD, supplied into the CPU 100. After the hardware polling enable signal HW_EN becomes active, the hardware polling processor 400 periodically outputs commands and addresses to the peripheral device 300 for the state read operation. The hardware polling processor 400 deactivates the hardware polling enable signal HW_EN when the current state data mismatch the previous state data. This enables the clock/power control unit 200 to supply the clock signal CLK, or clock signal CLK and target level of power source voltage VDD, into the CPU 100.

The hardware polling processor 400 is comprised of a control logic circuit 410, a register 420, and a comparator 430. The register 420, which stores state data and addresses, is regulated by the control logic circuit 410. The state data correspond to state data about the peripheral device 300 which is requested by the CPU 100 for an operation. The address is provided to designate the peripheral device 300. The comparator 430 is configured to compare the current state data with the state data stored in the register 420, being regulated by the control logic circuit 410. If the current state data match the state data stored in the register 420, the hardware polling enable signal HW_EN is activated. If there is an interrupt by the hardware polling processor 400 during a polling operation, the control logic circuit 410 regulates the comparator 430 to deactivate the hardware polling enable signal HW_EN. After generating the hardware polling enable signal HW_EN, the control logic circuit 410 regulates an operation of the comparator 430 and a data storage operation of the register 420 according to whether a command transferred through the control bus B2 is the command instructing a state read operation. Namely, after generating the hardware polling enable signal HW_EN, the control logic circuit 410 regulates the operation of the comparator 430 and the data storage operation of the register 420 when a command transferred through the control bus B2 is the state read command.

As can be understood from the aforementioned, the data processing system 1000 according to an embodiment of the present invention is organized to periodically check an operation state of the peripheral device 300 by means of the hardware polling processor 400. While monitoring an operation state of the peripheral device 300 by the hardware polling processor 400, it is permissible to interrupt the clock signal CLK to the CPU 100 and the program memory 500. As a result, power consumption of the CPU 100 and the program memory 500 during a state read operation to the peripheral device 300 is reduced.

Hereinafter will be detailed about an operation of the data processing system according to an embodiment of the present invention.

The CPU 100 requests an operation from the peripheral device 300. After requesting the operation from the peripheral device 300, the CPU 100 begins a state read operation for the peripheral device 300 by means of a program stored in the program memory 500. For this, the CPU 100 outputs a state read command and address to the program memory 500. The peripheral device 300 outputs state data, which is stored in the register 301, in response to the state read command applied thereto. The state data may represent an alternative one of busy and standby states. When the CPU 100 requests an operation, the peripheral device 300 sets the state register 301 to the busy state. After completing the operation requested by the CPU 100, the peripheral device 300 sets the state register 301 to the standby state.

After the state data are input to the CPU 100 through the data bus B3, the CPU 100 outputs a state read command and address to the peripheral device 300 again. Thereafter, the CPU 100 determines whether the previous state data match current state data output from the peripheral device 300. If the current state data mismatch the previous state data, the state read operation is terminated. Namely, the mismatch between the current state data (e.g., data informing of a standby state) and the previous data (e.g., data informing of a busy state) means that the operation has been terminated. Thus, a polling operation, i.e., the state read operation, is terminated.

If the current state data match the previous state data (e.g., the current state and previous state data informing of a busy state), the CPU 100 outputs a state read command and address to the peripheral device 300 again in order to fetch state data therefrom. At the same time, the CPU 100 generates the hardware polling flag signal F_HW_POLL. The control logic circuit 410 of the hardware polling processor 400 stores the ad dress, which is output from the CPU 100 and loaded on the address bus B1, and into the register 420 in response to the hardware polling flag signal F_HW_POLL. In particular, the control logic circuit 410 stores an address, which is present on the address bus B1, into the register 420 when a command on the control bus B2 represents the state read command. Subsequently, state data output from the peripheral device 300 are stored in the register 420 under regulation by the control logic circuit 410 of the hardware polling processor 400. Further, the state data output from the peripheral device 300 are transferred to the CPU 100. When current state data match the previous state data, the CPU 100 outputs a state read command and address to the peripheral device 300 again. The hardware polling flag signal F_HW_POLL is generated from the CPU 100.

The peripheral device 100 outputs state data from the state register 301 through the data bus B3 in response to the state read command provided from the CPU 100. During this, th e comparator 430 receives the state data from the data bus B3 under regulation by the control logic circuit 410 of the hardware polling processor 400. At the same time, the state data on the data bus B3 are transferred to the CPU 100. The comparator 430 compares the current state data with the previous state data stored in the register 420. If the current state data match the previous state data stored in the register 420, the comparator 430 activates the hardware polling enable signal HW_EN. The hardware polling enable signal HW_EN causes the clock signal CLK to the CPU 100 and the program memory 500 to be interrupted. Namely, the clock/power control unit 200 interrupts supply of the clock signal CLK to the CPU 100 and the program memory 500 in response to the hardware polling enable signal HW_EN. Along with the interruption of the clock signal CLK, a power source voltage VDD is lowered to reduce power consumption. According to the interruption of the clock signal CLK, the CPU 100 does not further conduct a polling operation, i.e., the state read operation. Subsequently, an operation for checking a state of the peripheral device 300 is automatically carried out under regulation of the hardware polling processor 400, as follows.

Once the hardware polling enable signal HW_EN is activated, the hardware polling processor 400 outputs an address, which is stored in the register 420, together with a state read command issued at predetermined intervals. As aforementioned, the peripheral device 300 outputs state data from the state register 301 to the data bus B3 in response to the state read command. The comparator 430 compares current state data with the previous state data stored in the register 420 under regulation of the control logic circuit 410. If the current state data match the previous state data stored in the register 420, the hardware polling enable signal HW_EN maintains its active condition. In response to the hardware polling enable signal HW_EN, the clock signal CLK is continuously interrupted to the CPU 100. Thereafter, a state read operation for the peripheral device 300 is repeated by the hardware polling processor 400 in the same sequence as aforementioned.

If the current state data does not match the state data stored in the register 420 (e.g., a current standby state and a previous busy state), the comparator 430 deactivates the hardware polling enable signal HW_EN. The clock/power control unit 200 supplies the clock signal CLK and the power source voltage VDD of target level to the CPU 100 and the program memory 500 in response to the deactivation of the hardware polling enable signal HW_EN.

The state read operation of the hardware polling processor 400 may be carried out every period that is longer than that of the CPU 100. This can be accomplished by adding a delay time to the clock signal CLK or adjusting a cycle time of the clock signal CLK by means of the control logic circuit 410 or the clock/power control unit 200.

As stated above, for cases having a long operation processing time, power consumption may be reduced by conducting a state read operation through the hardware polling processor 400, not through the CPU 100 that uses a specific program. In other words, as compared to the case of power consumption by the CPU 100 and the program memory 500, the hardware polling processor 400 has improved power efficiency in the data processing system. Therefore, it is possible to reduce power consumption.

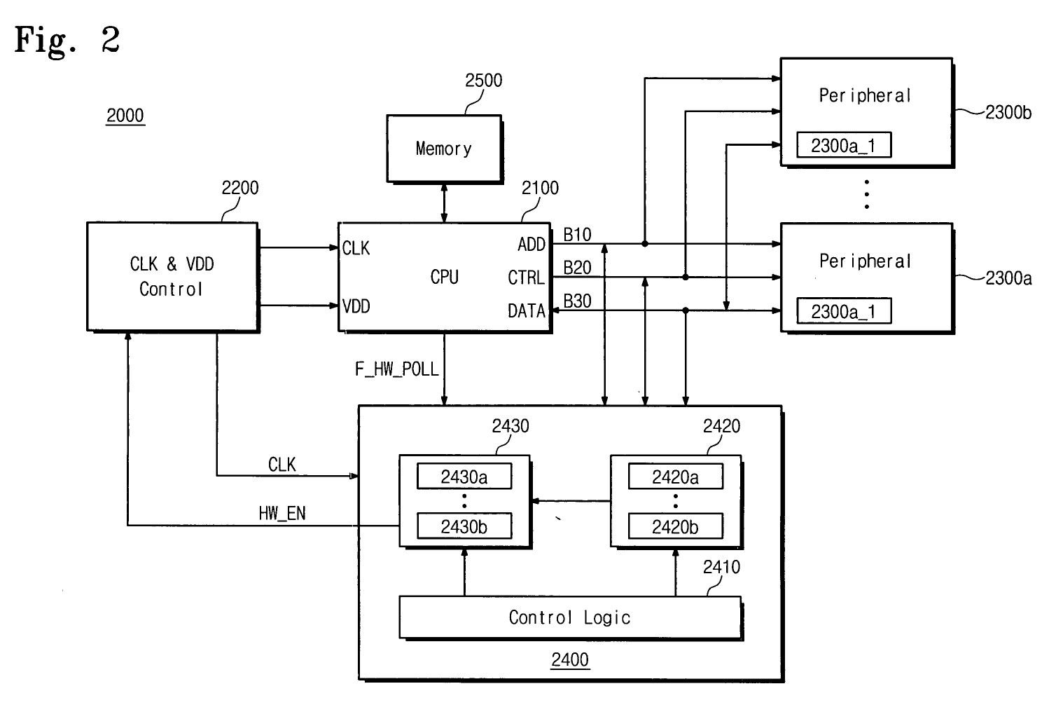

FIG. 2 is a block diagram schematically illustrating a data processing system in accordance with another embodiment of the present invention.

The data processing system 2000 shown in FIG. 2 is comprised of a CPU 2100, a clock/power control unit 2200, a plurality of peripheral devices 2300a˜2300b, a hardware polling processor 2400, and a program memory 2500. The peripheral devices 2300a˜2300b are connected to the CPU 2100 in parallel by way of buses B10, B20, and B30. The hardware polling processor 2400 is comprised of a control logic circuit 2410, a plurality of registers 2420a˜2420b, and a plurality of comparators 2430a˜2430b. Each of the registers 2420a˜2420b corresponds to one of the peripheral devices 2300a˜2300b, while each of the comparators 2430a˜2430b corresponds to one of the registers 2420a˜2420b (or the peripheral devices 2300a˜2300b). The registers 2420a˜2420b stores state data of the peripheral devices 2300a˜2300b corresponding thereto under the control of the control logic circuit 2410. The comparators 2430a˜2430b compare state data, which are output from the peripheral devices 2300a˜2300b, each with state data stored in the registers 2420a˜2420b in accordance with regulation by the control logic circuit 2410.

When the state data are twice read each from the peripheral devices 2300a˜2300b, the CPU 2100 of the data processing system 200 shown in FIG. 2 generates the hardware polling flag signal F_HW_POLL. Subsequently, the hardware polling flag signal F_HW_POLL may be generated again by the CPU 2100. This enables state read operations of the peripheral devices 2300a˜2300b to be carried out by the hardware polling processor 2400 instead of the CPU 2100. The state read operations of the hardware polling processor 2400 are substantially same as that described with respect to FIG. 1, except that: the state data are read respectively from the peripheral devices 2300a˜2300b; and the hardware polling enable signal HW_EN is deactivated when state data output from at least one of the peripheral devices 2300a˜2300b are different from state data stored in its corresponding register. Therefore, further discussion will be omitted.

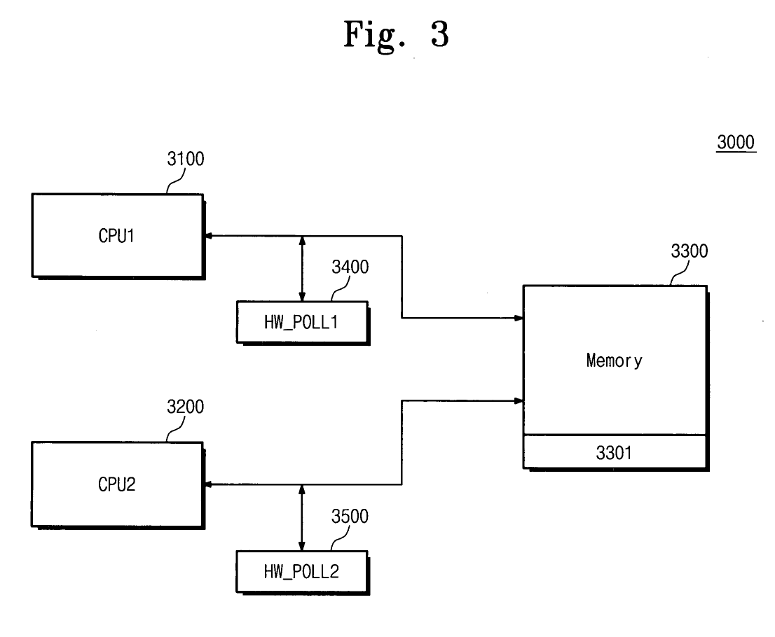

FIG. 3 is a block diagram schematically illustrating a data processing system in accordance with still another embodiment of the present invention.

The data processing system shown in FIG. 3 is comprised of two CPUs 3100 and 3200, a common memory 3300, and two hardware polling processors 3400 and 3500. The common memory 3300 is shared by the CPUs 3100 and 3200. The common memory 3300 includes a state data storage field 3301 for storing state data. The state data are written into the storage field 3301 by the CPUs. For example, when the CPU 3100 is accessing the common memory 3300, the CPU 3200 stores data of busy state into the data storage field 3301 of the common memory 3300. When the CPU 3200 is accessing the common memory 3300, the CPU 3100 stores data of busy state into the data storage field 3301 of the common memory 3300.

The hardware polling processor 3400 is coupled in parallel to a bus between the CPU 3100 and the common memory 3300, automatically executing the state read operation as aforementioned. The hardware polling processor 3500 is coupled in parallel to a bus between the CPU 3200 and the common memory 3300, automatically executing the state read operation as aforementioned. Each of the hardware polling processors 3400 and 3500 is substantially same as that described with respect to FIG. 1. Therefore, further discussion will be omitted.

Since a state read operation by the CPU (e.g., 3100) for the common memory 3300 is carried out the hardware polling processor (e.g., 3400) corresponding thereto, it is possible to reduce power consumption of the CPU 3100. Further, since a state read operation by the CPU (e.g., 3200) for the common memory 3300 is carried out the hardware polling processor (e.g., 3500) corresponding thereto, it is possible to reduce power consumption of the CPU 3200. For convenience of description, FIG. 3 does not illustrate the clock/power control unit and the program memory. It may be understand that the clock/power control unit and the program memory are provided for each of the CPUs. The clock/power control unit and the program memory may be shared by the CPUs 3100 and 3200. In the case of a shared clock/power control unit and the program memory, when the hardware polling processor 3400 is operating, the clock/power control unit may interrupt the clock signal to the CPU 3100. When the hardware polling processor 3500 is operating, the clock/power control unit may interrupt the clock signal to the CPU 3200.

The hardware polling flag signal F_HW_POLL may be generated at the same time with the beginning of the first state read operation.

As described above, when there is a need for a long processing time in operation, power consumption may be reduced in reading an operation state by conducting a state read operation through the hardware polling processor, not through the CPU that uses a specific program.

The above-disclosed subject matter is to be considered illustrative, and not restrictive, and the appended claims are intended to cover all such modifications, enhancements, and other embodiments, which fall within the true spirit and scope of the disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A data processing system comprising:
a processor;
a peripheral device conducting an operation requested by the processor;
a clock/power control unit supplying a clock signal to the processor; and
a hardware polling processor detecting current state data output from the peripheral device and regulating the clock/power control unit to interrupt the clock signal to the processor in accordance with a result of the detection, during a state read operation for detecting current state data output from the peripheral device.

2. The data processing system as set forth in claim 1, wherein when the clock signal is interrupted to the processor, the hardware polling processor conducts the state read operation.

3. The data processing system as set forth in claim 2, wherein when the state data output from the peripheral device represent a standby state, the hardware polling processor regulates the clock/power control unit to supply the processor with the clock signal.

4. The data processing system as set forth in claim 1, wherein the processor generates a hardware polling flag signal when the current state data output from the peripheral device match previous state data output from the peripheral device.

5. The data processing system as set forth in claim 4, wherein the hardware polling processor stores an address, which is to be provided to the peripheral device, and the state data output from the peripheral device, in response to the hardware polling flag signal.

6. The data processing system as set forth in claim 5, wherein when the processor requests the state read operation from the peripheral device after generation of the hardware polling flag signal, the hardware polling processor determines whether the current state data output from the peripheral device match the previously stored state data.

7. The data processing system as set forth in claim 6, wherein when the current state data output from the peripheral device match the previously stored state data, the hardware polling processor regulates the clock/power control unit to interrupt the clock signal to the processor.

8. The data processing system as set forth in claim 6, wherein when the current state data output from the peripheral device mismatch the previously stored state data, the hardware polling processor regulates the clock/power control unit to supply the processor with the clock signal.

9. The data processing system as set forth in claim 4, wherein when a command output from the processor instructs the state read operation, the hardware polling processor stores an address, which is to be provided to the peripheral device, and the current state data output from the peripheral device, in response to the hardware polling flag signal.

10. The data processing system as set forth in claim 6, wherein when the current state data output from the peripheral device match the previously stored state data, the hardware polling processor regulates the clock/power control unit to interrupt the clock signal to the processor and to lower a power source voltage less than a target level.

11. The data processing system as set forth in claim 4, wherein the hardware polling processor comprises:
a control logic circuit operating in response to the hardware polling flag signal;
a register regulated by the control logic circuit, storing an address output to the peripheral device and the current state data output from the peripheral device when the hardware polling flag signal is generated; and
a comparator regulated by the control logic circuit, comparing the current state data with the stored state data of the register.

12. The data processing system as set forth in claim 11, wherein when the current state data output from the peripheral device match the previously stored state data of the register, the comparator generates a hardware polling enable signal.

13. The data processing system as set forth in claim 12, wherein the clock/power control unit interrupts the clock signal to the processor in response to activation of the hardware polling enable signal.

14. The data processing system as set forth in claim 13, wherein when there is an interrupt during the state read operation by the hardware polling processor, the control logic circuit regulates the comparator to deactivate the hardware polling enable signal.

15. The data processing system as set forth in claim 13, wherein after activation of the hardware polling enable signal, the comparator deactivates the hardware polling enable signal when the current state data output from the peripheral device mismatch the previously stored state data of the register.

16. The data processing system as set forth in claim 15, wherein the clock/power control unit supplies the clock signal to the processor in response to deactivation of the hardware polling enable signal.

17. A data processing system comprising:
a processor;
a peripheral device conducting an operation requested by the processor;
a clock/power control unit supplying a clock signal to the processor; and
a hardware polling processor regulating the clock/power control unit during a state read operation for detecting current state data of the peripheral device,
wherein the processor generates a first hardware polling flag signal when the current state data of the peripheral device match previous state data,
wherein the hardware polling processor comprises:
a control logic circuit operating in response to the first hardware polling flag signal output from the processor;
a register regulated by the control logic circuit, storing an address output to the peripheral device and the current state data of the peripheral device when the first hardware polling flag signal is generated; and
a comparator regulated by the control logic circuit, comparing the current state data with stored state data of the register,
wherein the comparator generates a second hardware polling enable signal when the current state data of the peripheral device match the stored state data of the register,
wherein the clock/power control unit interrupts the clock signal to the processor in response to activation of the hardware polling enable signal.

18. The data processing system as set forth in claim 17, wherein after activation of the second hardware polling enable signal, the comparator deactivates the hardware polling enable signal when the current state data output from the peripheral device mismatch the previously stored state data of the register.

19. The data processing system as set forth in claim 18, wherein the clock/power control unit supplies the clock signal to the processor in response to deactivation of the hardware polling enable signal.

20. The data processing system as set forth in claim 17, wherein when a command output from the processor instructs the state read operation, the hardware polling processor stores the address, which is to be provided to the peripheral device, and the current state data output from the peripheral device, in response to the first hardware polling flag signal.

21. The data processing system as set forth in claim 17, wherein when there is an interrupt during the state read operation by the hardware polling processor, the control logic circuit regulates the comparator to deactivate the second hardware polling enable signal.

22. A data processing system comprising:
first and second processors;
a memory shared by the first and second processors, including a field for storing operation state data of the first and second processors; and
first and second hardware polling processors configured to process state read operations in correspondence each with the first and second processors,
wherein each of the first and second hardware polling processors is the hardware polling processor described in claim 1.
